(19) United States
(12) Patent Application Publication
(10) Pub. No.: US 2026/0120241 A1
(43) Pub. Date: Apr. 30, 2026

(54) STEERING-MOUNTED DISPLAY PANEL SYSTEM

(71) Applicant: Kostal of America, Inc., Troy, MI (US)

(72) Inventors: Paul W. Kissel, Waterford, MI (US); Xiaozhong Duan, Troy, MI (US)

(73) Assignee: Kostal of America, Inc., Troy, MI (US)

(21) Appl. No.: 18/927,371

(22) Filed: Oct. 25, 2024

(51) Int. Cl. G06T 3/60; B60K 35/22; B60K 35/25; G06F 3/01

(52) U.S. Cl. CPC G06T 3/60; B60K 35/22; B60K 35/25; G06F 3/016; B60K 2360/1438; B60K 2360/782

(57) ABSTRACT

A steering-mounted display panel system includes an electronic display panel mounted on a steering wheel; a steering angle sensor for detecting an angle of rotation of the steering wheel; memory for storing information for generating a graphic image; a graphics processing unit configured to extract information for generating a graphic image from the information stored on the memory, apply an image transformation of the graphic image to generate a modified image that rotates the image by an angle equal to and opposite to the angle of rotation of the steering wheel detected by the sensor, and displaying the modified image; a two-axes accelerometer configured to sense angular acceleration of the steering wheel; and a processor configured to determine whether data from the steering angle sensor and the two-axes accelerometer are in agreement.

### FIELD OF THE DISCLOSURE

This disclosure relates generally to vehicle instrument display panels, and more particularly to a display panel located on a rotatable steering wheel.

### BACKGROUND OF THE DISCLOSURE

It is desirable to present information to a driver on a display that is located directly in front of the vehicle driver and near the bottom edge of the vehicle windshield. This position of the display allows a driver to easily shift focus between traffic and the display. Important information has been conventionally displayed on an instrument panel located between a steering wheel and the windshield. However, depending on how the driver positions the driver's seat and steering wheel, portions of the steering wheel can obscure viewing of the display requiring the driver to move their head up, down, left or right. This can be both annoying and distracting. A recognized solution has been to position a display panel on the steering wheel, such as on a hub portion of a steering wheel.

A problem with fixing a display panel on a steering wheel is that the image will be rotated relative to a vertical line when the steering wheel is rotated, making it somewhat more difficult to read information from the display during turning of the vehicle. A proposed solution to this problem is to provide a display control device that rotates the displayed image to compensate for rotation of the steering wheel so that the displayed image is kept constant relative to a vertical reference line. Such solution relies on information from a steering angle sensor that can generate erroneous data, which in turn could actually cause the displayed image to rotate inappropriately, making viewing of the information difficult.

Additionally, known vehicle steering-mounted display panel systems have not adequately addressed the ability to select activation of vehicle functions via a touch pad located on the steering device.

### SUMMARY OF THE DISCLOSURE

In certain aspects of this disclosure, a vehicle steering-mounted display panel system includes a vehicle steering device, such as a steering wheel; an electronic display panel (e.g., LDC or LED) fixed on the vehicle steering device; a steering angle sensor for detecting an angle of rotation of the steering device relative to a vertical reference line (e.g., a line normal to a plane defined by the length and width directions of the vehicle); memory storing information for generating a graphic image; a graphics processing unit configured to extract information for generating a graphic image from the memory, and apply a two-dimensional image transformation of the graphic image to generate a modified graphic image that is rotated by an angle equal to the detected angle of rotation of the vehicle steering device in an opposite angular direction, and displaying the modified graphic image on the display panel; a two-axes accelerometer configured to sense angular acceleration of the vehicle steering device; and a processor configured to determine whether data from the steering angle sensor and the two-axes accelerometer are in agreement.

In some aspects of this disclosure, a vehicle steering-mounted display panel system includes a vehicle steering device; a touch screen display panel fixed on the vehicle steering device; a steering angle sensor for detecting an angle of rotation of the steering device relative to a vertical reference line (e.g., a line normal to a plane defined by the length and width directions of the vehicle); memory for storing information for generating a graphic image; a graphics processing unit configured to extract information for generating a graphic image from the information stored in the memory, to apply a two-dimensional image transformation of the graphic image to generate a modified graphic image that is rotated by an angle equal to the detected angle of rotation of the vehicle steering device in an opposite angular direction, and displaying the modified graphic image on the display panel.

### BRIEF DESCRIPTION OF THE DRAWINGS

FIG. 1 is a schematic illustration of the disclosed steering-mounted display system.

FIG. 2 is a schematic side view of a user and steering-mounted display.

FIG. 3 is a front view of a steering-mounted display panel.

FIG. 4 is a schematic illustration of a system having force sensors for determining user touch commands.

FIG. 5 is a process flow diagram for presenting an image on the steering-mounted display system and taking corrective measures of steering sensor and accelerometer data are not in agreement.

FIGS. 6A-6C are depictions of an image transformation performed by a graphics processing unit.

FIG. 7 illustrates a steering-mounted display system having screen touch sensors and haptic feedback mechanisms.

FIG. 8 is a process flow diagram for evaluating and responding to user touch ON/OFF screen sensors located adjacent function display on the screen.

### DETAILED DESCRIPTION

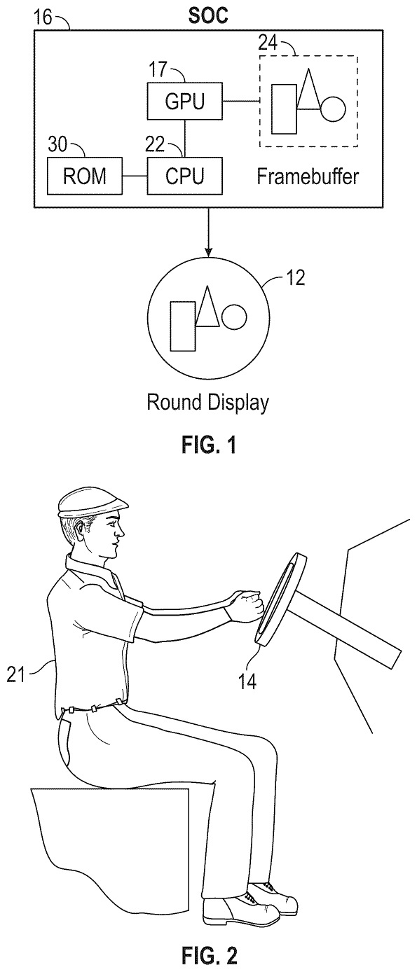

A vehicle steering-mounted display system (FIG. 1) refers to a steering device for a vehicle (e.g., a steering wheel) having an electronic display fixed on a surface thereof (e.g., the hub of the steering wheel), and can include memory, processor(s), graphic processing units), sensor(s), and other components used to display an image on the display.

Steering devices include various manual vehicle steering mechanisms, such as steering wheels having a generally circular hand gripping portion connected to a hub, yolk steering devices generally having a U-shape with opposite laterally disposed hand grips connected to a hub, and joystick steering device.

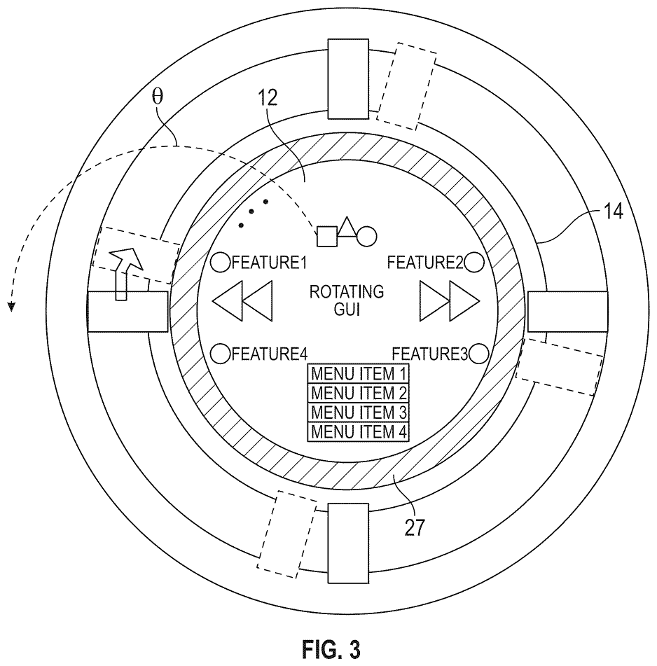

The display panel 12 (FIGS. 2 and 3) can be any type of electronic display capable of presenting images from a processor and/or graphic processing unit, including various liquid-crystal displays (LCDs), such as light-emitting diode (LED) backlit LCD, thin-film transistor (TFT) LCD, and quantum dot (QLED) displays, LED displays, such as organic light emitting displays (OLEDs), and active-matrix organic LEDs (AMOLEDs).

In order to facilitate driver 21 activation of vehicle features, the display panel can be a touch-screen display that presents an image that offers a selection of vehicle features (e.g., sound system volume control, cabin temperature control, etc.) that can be activated through the touch-screen.

Any of various known steering angle sensors can be used in the disclosed vehicle steering-mounted display panel systems, including inductive angle sensors that rely on the principle of electromagnetic induction, optical sensors-type, potentiometer-type, and/or Hall effect steering angle sensors.

The memory can be a non-volatile, read-only memory chip (ROM) 30, or other type of memory that retains stored information even when power is removed, such as hard disk drives or optical discs.

The graphics processing unit can be a separate dedicated chip, integrated into a central processing unit, or a general-purpose processor.

Graphical user interfaces (GUIs) allow users to interact with a software application through a display 12, usually driven by a system-on-chip (SOC) 16 or microcontroller (MCU) using a graphics processing unit (GPU) 17. The SOC or MCU uses the GPU to render an image in an area of memory called a framebuffer. The SOC or MCU then outputs this image to the connected display (FIG. 1). In addition, some displays provide a touch function allowing the user or operator to activate functions and features located on the display by simply touching the display.

Mounting a display to the center of the steering wheel without compensating for steering device rotation creates a problem. When the user turns the steering wheel and displayed image is also rotated the display (FIG. 2). This will make it awkward for the user or operator to interact with the display and its touch applications.

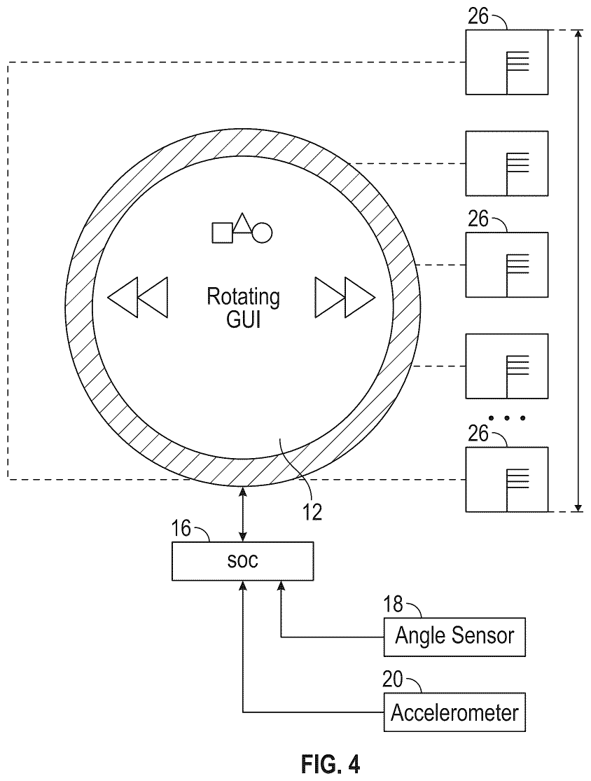

A solution for maintaining the orientation of the display mounted to the center of a rotating steering wheel is provided. A round display 12 is mounted to the center of the steering wheel 14 (FIG. 3). An SOC 16 is connected to an angle sensor 18 affixed to the shaft of the rotating steering wheel and a 2-axes accelerometer 20 capable of measuring angle of rotation of the steering wheel (FIG. 4) is provided.

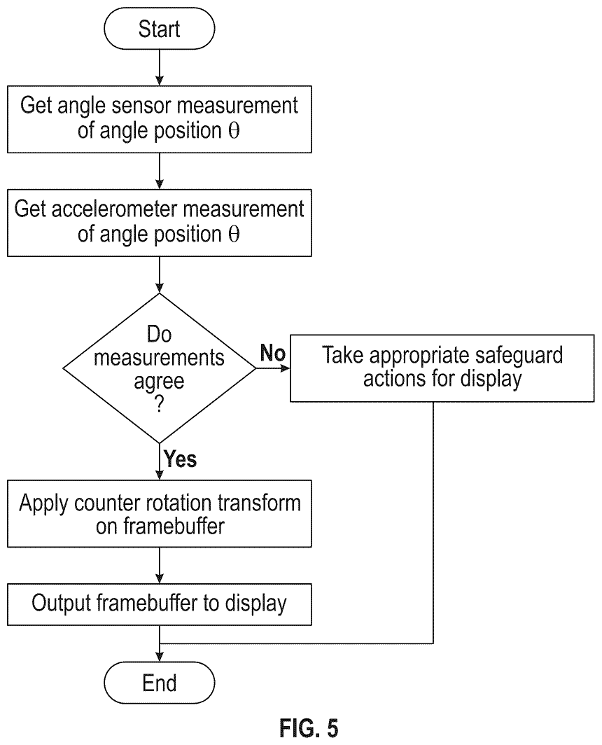

When the user or operator 21 rotates the steering wheel by a certain angle (theta, θ), the angle sensor affixed to the shaft of the rotating steering wheel (hereafter referred to as steering angle sensor) senses the change in rotation by θ. The 2-axes accelerometer also senses the acceleration in angulator movement of θ. The aforementioned SOC uses this information from the accelerometer as a redundant check on the steering angle sensor reading (FIG. 5).

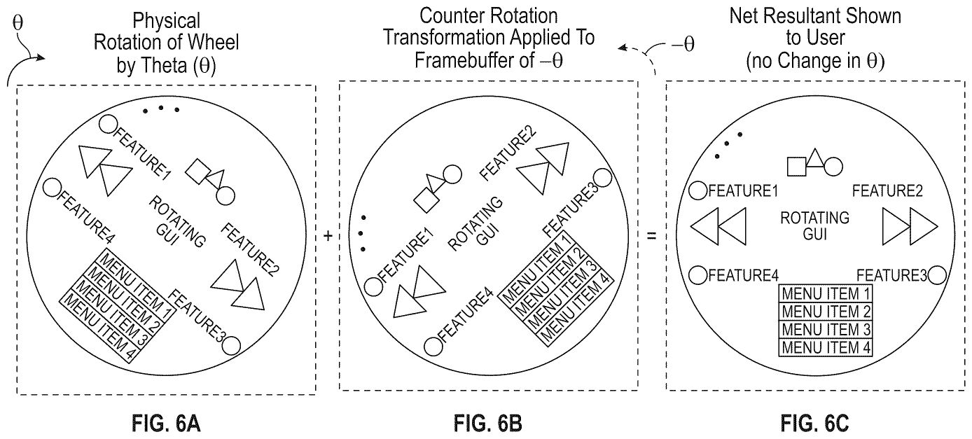

Based on the change in angular position measured by the steering angle sensor (FIG. 6A), the SOC uses the GPU 22 and applies a 2D image transformation to the image in its framebuffer 24. The image transformation is a rotation effect of −θ applied in the opposite direction of the steering angle sensor's measurement (FIG. 6B). The net result (θ−θ=0) is that the image displayed to the user stays in the same orientation as before rotation (FIG. 6C).

Because the SOC through the image rotation maintains the orientation of the image without any apparent change in angle, the user can look at the display and still read the information shown on the display. Additionally, they can touch the display to activate touch features in the same relative location.

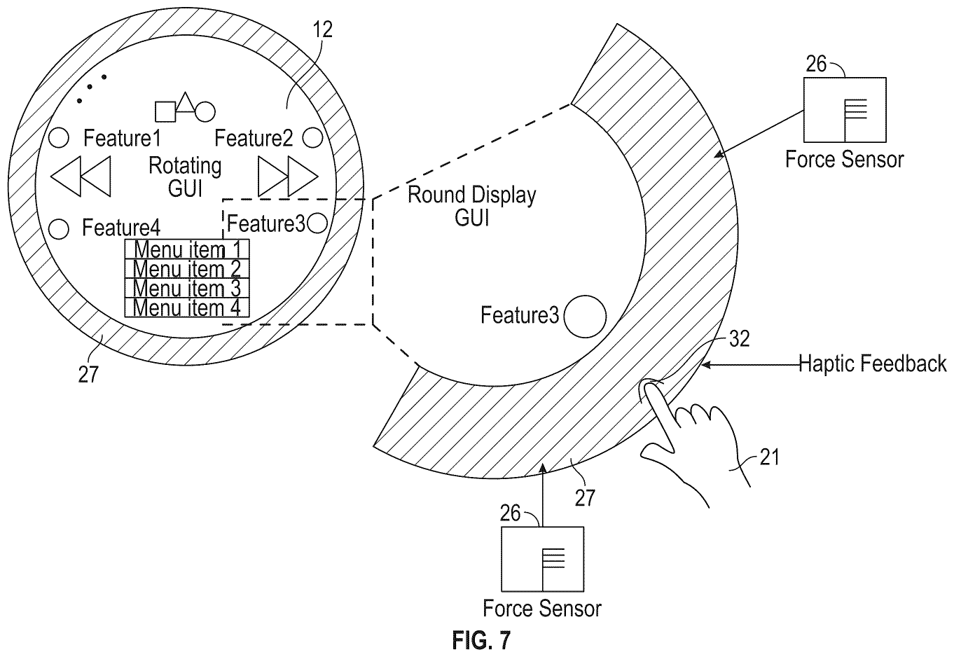

In addition, the SOC utilizes this advantage to support force sensing elements 26 (FIG. 4) located around the display at a user interface surface 27 (FIGS. 3 and 4). The SOC samples the force sensors located in the surface to determine the location at which the user pressing is upon the surface. For example, the user 21 can touch the surface near a feature or menu selection shown on the display. The SOC can provide an optional haptic feedback such as with vibrating components 32 (e.g., motor or linear resonant actuator) when the user presses on the surface (FIG. 7).

As illustrated in FIG. 5, the steering angle sensor 18 and accelerometer 20 measurements are obtained and compared. If the data from the steering angle sensor and accelerometer are in agreement, GPU 22 creates and displays a modified image on display 12 that compensates for steering wheel rotation. If the data from the steering angle sensor and accelerometer are not in agreement (allowing for some tolerable deviation), appropriate safeguard actions for the display can be taken. For example, the display can be locked into a neutral position in which the image is fixed so that it is properly oriented for normal reading when the steering wheel is physically unrotated relative a reference line.

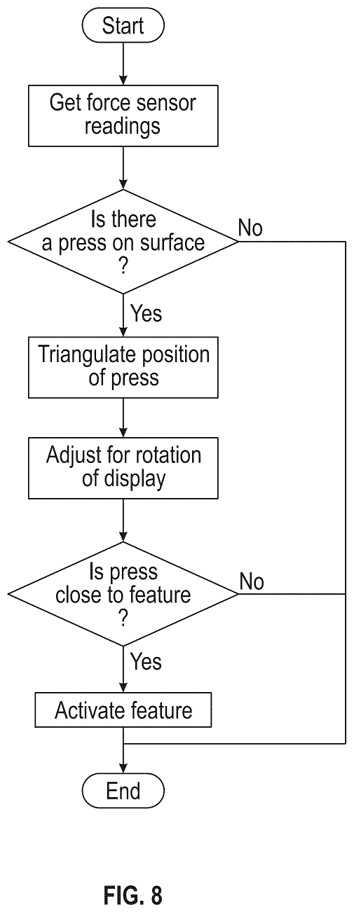

The menu selection of a feature stays in the same location relative to the user, and the SOC triangulates with software to determine where the user is pressing on the surface. Since the SOC is adjusting for rotation of the display it will determine if the press is in fact close enough to the feature to activate it (FIG. 8) and can provide haptic feedback if the user is touching the force sensing surface next to the feature.

With these advantages, the user can either activate features directly on the touch display or by pressing adjacent to the displayed feature on the force sensing surface and optionally receive haptic feedback.

This solution keeps the display oriented while the user turns the steering wheel. The accelerometer can be used to verify the steering angle sensor readings. Haptics in the force-sensing surface can give mechanical feedback when an operator activates a feature by pressing along the surface near the display.

The above description is intended to be illustrative, not restrictive. The scope of the invention should be determined with reference to the appended claims along with the full scope of equivalents. It is anticipated and intended that future developments will occur in the art, and that the disclosed devices, kits and methods will be incorporated into such future embodiments. Thus, the invention is capable of modification and variation and is limited only by the following claims.

1. A vehicle steering-mounted display panel system, comprising:
a vehicle steering device;
an electronic display panel fixed on the vehicle steering device;
a steering angle sensor for detecting an angle of rotation of the vehicle steering device relative to a reference line;
a memory for storing information for generating a graphic image;
a graphics processing unit configured to extract information from the memory for generating a graphic image, apply a two-dimensional image transformation to the graphic image to generate a modified graphic image that is rotated by an angle equal to the angle of rotation of the vehicle steering device in an opposite angular direction, and display the modified graphic image on the display panel;
a two-axes accelerometer configured to sense angular acceleration of the vehicle steering device; and
a processor configured to determine whether data from the steering angle sensor and the two-axes accelerometer are in agreement.

2. The vehicle steering-mounted display panel system of claim 1, wherein the electronic display panel is a touch-screen display panel.

3. The vehicle steering-mounted display panel system of claim 1, wherein the electronic display panel is round.

4. The vehicle steering-mounted display panel system of claim 1, further comprising a plurality of force sensors located around the display.

5. The vehicle steering-mounted display panel system of claim 4, further comprising a vibrating component to provide haptic feedback associated with force being determined by a force sensor.

6. A vehicle steering-mounted display panel system, comprising:
a vehicle steering device;
a touch screen display panel fixed on the vehicle steering device;
a steering angle sensor for detecting an angle of rotation of the vehicle steering device relative to a reference line;
a memory for storing information for generating a graphic image; and
a graphics processing unit configured to extract information from the non-volatile memory for generating a graphic image, apply a two-dimensional image transformation to the graphic image to generate a modified graphic image that is rotated by an angle equal to the angle of rotation of the vehicle steering device in an opposite angular direction, and display the modified graphic image on the display panel.

7. The vehicle steering-mounted display panel system of claim 6, further comprising a two-axes accelerometer configured to sense angular acceleration of the vehicle steering device; and a processor configured to determine whether data from the steering angle sensor and the two-axes accelerometer are in agreement.

8. The vehicle steering-mounted display panel system of claim 6, wherein the electronic display panel is round.

9. The vehicle steering-mounted display panel system of claim 6, further comprising a plurality of force sensors located around the display.

10. The vehicle steering-mounted display panel system of claim 9, further comprising a vibrating component to provide haptic feedback associated with force being determined by a force sensor.
